(19) United States
(12) Patent Application Publication
(10) Pub. No.: US 2023/0030217 A1
(43) Pub. Date: Feb. 2, 2023

(54) SYSTEMS AND METHODS FOR ORGANIZING DISPLAYS OF SOFTWARE APPLICATIONS RUNNING ON A DEVICE

(71) Applicant: Derek Charter Diamond, Port Alfred (ZA)

(72) Inventor: Derek Charter Diamond, Port Alfred (ZA)

(21) Appl. No.: 17/714,686

(22) Filed: Apr. 6, 2022

Related U.S. Application Data
(60) Provisional application No. 63/228,595, filed on Aug. 2, 2021.

(51) Int. Cl. G06F 3/0481; G06F 11/30

(52) U.S. Cl. CPC G06F 3/0481; G06F 11/3017; G06F 11/302

(57) ABSTRACT

The present disclosure provides a method for organizing displays of software applications running on a device. Further, the method may include receiving one or more software application information from a device. Further, the method may include detecting one or more application states of the one or more software applications based on the one or more software application information. Further, the method may include generating one or more visual elements for the one or more software applications based on the one or more application states. Further, the method may include generating user interface data for rendering a user interface on the device based on the generating of the one or more visual elements for the one or more software applications. Further, the method may include transmitting the user interface data to the device.

### FIELD OF DISCLOSURE

The present disclosure generally relates to the field of data processing. More specifically, the present disclosure relates to systems and methods for organizing displays of software applications running on a device.

### BACKGROUND

A system for organizing the content displays of various software applications is in demand. Today, people use computer devices daily. Computer devices and software provide convenient communication methods, automated processes, and various useful features necessary and helpful in making people's lives easier.

With technological advancements, new computer systems, including mobile devices and software, are being released by computer companies every week. Computer devices are being manufactured to support an increasing number of functions and a variety of software applications. Consequently, computer devices and software applications are getting more and more complicated to use.

Many people, from kids to professionals, also feel the need to keep up with current market trends and use the latest, most-advanced computer device available on the market. Acquiring new software applications is made easy and economical with Internet technology advancements and software systems designed to download new software via the Internet.

However, increased complexity leads to the increased time spent trying to understand how to use the computer device and software. It also increases the time spent using multiple software applications simultaneously. People use monitors or phone screens to view and manipulate numerous software applications. Despite a large number of computer devices available on the market, the display screen on which users view multiple software applications has limited space, causing difficulty remembering the viewing states of the applications and organizing multiple software applications running simultaneously. Software applications, including web applications, games, and professional applications, are typically designed to show multiple states or stages that indicate the progress of the software and include various features that users can navigate, but when users are operating multiple applications at the same time, it becomes difficult to remember the previous states of an application when the user wants to go back or open specific windows when multiple application windows or websites are hiding behind the foremost open window.

Therefore, there is a need for systems and methods for organizing displays of software applications running on a device that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method for organizing displays of software applications running on a device. Further, the method may include receiving, using a communication device, at least one software application information associated with at least one software application from the device. Further, the at least one software application may be executed on the device. Further, the method may include detecting, using a processing device, at least one application state of the at least one software application based on the at least one software application information. Further, the method may include generating, using the processing device, at least one visual element for the at least one software application based on the at least one application state. Further, the at least one visual element corresponds to the at least one application state. Further, the method may include generating, using the processing device, user interface data for rendering a user interface on the device based on the generating of the at least one visual element for the at least one software application. Further, the user interface may display the at least one visual element of the at least one software application on the device based on the user interface. Further, the method may include transmitting, using the communication device, the user interface data to the device. Further, the method may include storing, using a storage device, at least one of the at least one application state and the at least one visual element.

The present disclosure provides a system for organizing displays of software applications running on a device. Further, the system may include a communication device. Further, the communication device may be configured for receiving at least one software application information associated with at least one software application from the device. Further, the at least one software application may be executed on the device. Further, the communication device may be configured for transmitting user interface data to the device. Further, the system may include a processing device communicatively coupled with the communication device. Further, the processing device may be configured for detecting at least one application state of the at least one software application based on the at least one software application information. Further, the processing device may be configured for generating at least one visual element for the at least one software application based on the at least one application state. Further, the at least one visual element corresponds to the at least one application state. Further, the processing device may be configured for generating the user interface data for rendering a user interface on the device based on the generating of the at least one visual element for the at least one software application. Further, the user interface may display the at least one visual element of the at least one software application on the device based on the user interface data. Further, the system may include a storage device communicatively coupled with the processing device. Further, the storage device may be configured for storing at least one of the at least one application state and the at least one visual element.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 illustrates a flowchart of a method for organizing displays of software applications running on a device, in accordance with some embodiments.

FIG. 4 illustrates a flowchart of the method for organizing displays of software applications running on a device including analyzing, using a processing device, at least one visual element information, wherein generating of the at least one visual element for at least one software application is further based on the analyzing of the at least one visual element information, in accordance with some embodiments.

FIG. 5 illustrates a flowchart of the method for organizing displays of software applications running on a device including storing, using a storage device, at least one annotation, in accordance with some embodiments.

FIG. 6 illustrates a flowchart of the method for organizing displays of software applications running on a device including storing, using a storage device, at least one visual linking element, in accordance with some embodiments.

FIG. 7 illustrates a flowchart of the method for organizing displays of software applications running on a device including storing, using a storage device, at least one arrangement, in accordance with some embodiments.

FIG. 8 illustrates a flowchart of the method for organizing displays of software applications running on a device including transmitting, using a communication a device, at least one application state to the device, wherein the device sets at least one software application in the at least one application state based on the at least one application state, in accordance with some embodiments.

FIG. 9 illustrates a flowchart of the method for organizing displays of software applications running on a device including storing, using a storage device, at least one updated application state, wherein the at least one updated application state is retrievable based on identifying of at least one visual element, in accordance with some embodiments.

FIG. 10 illustrates a flowchart of the method for organizing displays of software applications running on a device including determining, using a processing device, an importance of each of a plurality of application states of at least one software application based on analyzing of the at least one software application information, wherein detecting of at least one application state of the at least one software application further comprises identifying the at least one application state from the plurality of application states based on the importance of each of the plurality of application states, in accordance with some embodiments.

FIG. 11 illustrates a block diagram of a system for organizing displays of software applications running on a device, in accordance with some embodiments.

FIG. 12 illustrates a block diagram of the system for organizing the displays of the software applications running on the device, in accordance with some embodiments.

FIG. 13 illustrates a block diagram of a storyboard system for organizing displays of software applications running on a device, in accordance with some embodiments.

FIG. 14 illustrates a block diagram of the storyboard system, in accordance with some embodiments.

FIG. 15 illustrates a user interface of the device, in accordance with some embodiments.

FIG. 16 illustrates storyboard interfaces associated with the storyboard system, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating management of employee data, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes systems and methods for organizing displays of software applications running on a device.

Further, the present disclosure generally relates to software presentations. The present disclosure relates to a storyboard designed to organize how software applications are displayed.

Further, the present disclosure describes an innovative software system. Further, the innovative software system may be designed to provide a convenient means of organizing and controlling various software applications.

Further, the present disclosure describes a method of controlling the view state and location of software applications from an external separate window using a diagram-based approach where selecting a diagram element brings up associated locations and windows in the software application connected to the element, as well as associated annotation describing the software application state just invoked.

When showing the various states of a software application, the open windows, screen positions, and data are made visible/invisible in the application windows and the location and view of the data in the application windows. For example, in a geographic information system, the map windows, the location and zoom levels of the maps, and the current map themes and layer visibilities would be shown. In a dashboard application, the various dashboard windows, the charts, and the data filter applied to the data in each window would be shown. There is a sequence, context, and flow among these states that is not recorded in the software applications. Also, each state can have an annotation containing any kind of text or markup or even images or graphs to further illustrate or highlight the associated state of the software application.

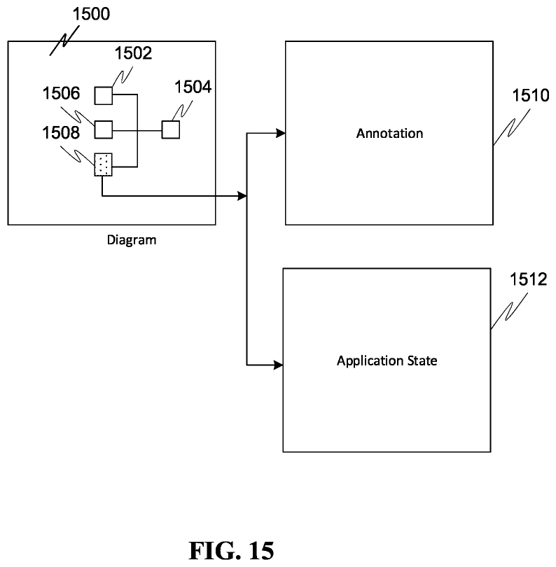

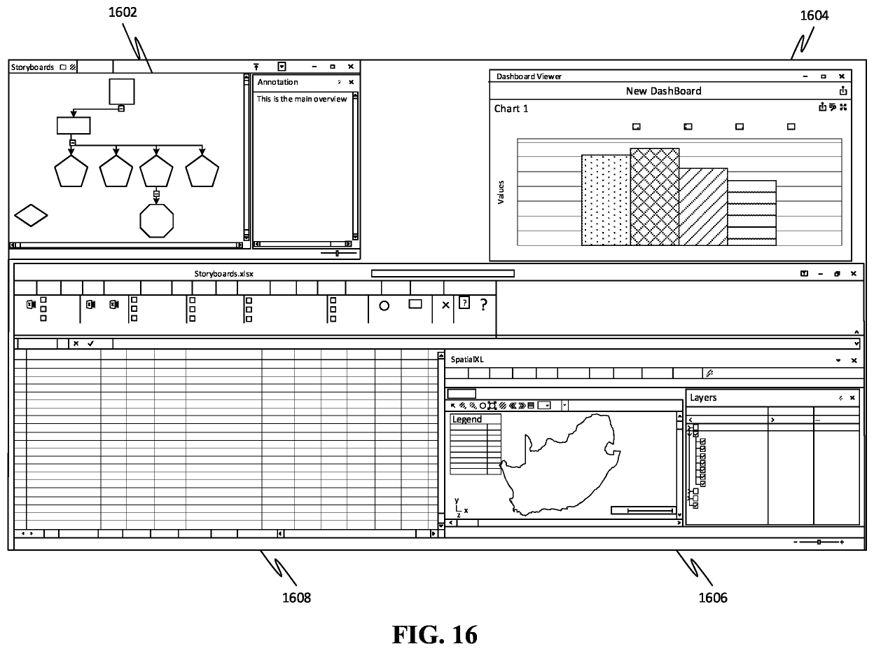

The diagram (as shown in FIG. 15 and FIG. 16) may show the logical links and sequencing of the software application states according to the narrative being illustrated.

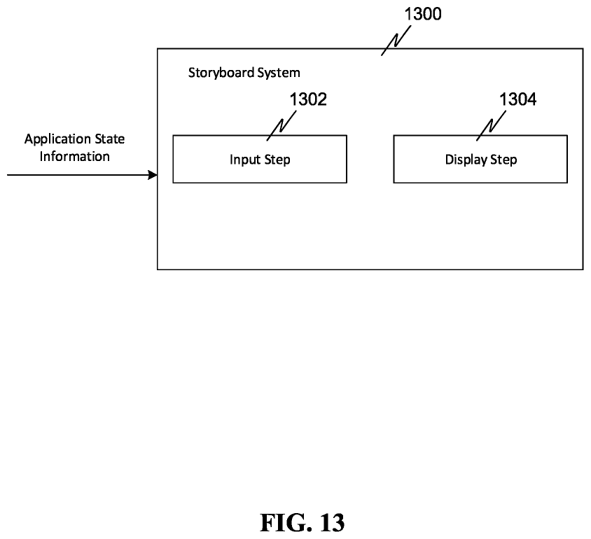

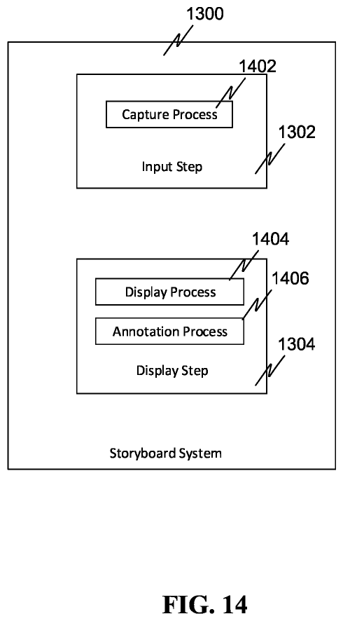

The disclosed system allows a user to organize, sequence, and annotate various states of a software application for later replay or review and amendment. The disclosed system provides a framework for collecting and replaying the concepts, intentions, or narratives the user wants to present or manipulate. FIG. 13 shows a storyboard system that comprises multiple processors and memories, with the latter containing instructions that when executed by a processor, trigger an input step and a display step. The instructions may include routines, programs, objects, data structures, and the like. The storyboard system can be implemented in a network environment that may comprise one or more servers. In some embodiments, a software product of the disclosed system can be downloaded in a user computing system via a network. The input step, as shown in FIG. 14 and FIG. 15, may include a process to capture multiple software application states to generate a diagram to organize various software applications. In one embodiment, the input step may be configured to allow the user to create an empty diagram by clicking on a menu item display that may be included in the input step. In another embodiment, the input step may further include a mechanism to allow users to set up the storyboard background image and style of the storyboard system diagram. In some other embodiments, the input step can include an application user interface configured to navigate to the first application state that the user desires to capture. The input step may include a capture process to choose and store all the application information related to the application state in storage in a way that allows the user to leave some parts of the application states unchanged and replay the captured states any time later. The display step, as shown in FIG. 14 and FIG. 15, may include an icon display process that chooses an icon to be placed on the diagram of the storyboard system. In some embodiments, the icon display process associates the icons with all the software application elements stored during the capture process. After initiating the display step, the display step may allow the user to set different application states by opening or closing windows in the software application, panning and zooming within application windows, or otherwise setting the application state and then adding more icons to the diagram of the storyboard system. When the software product of the storyboard system is shut down and closed, all the operating information, including the last selected icons, can be saved in a storage device that may be communicatively connected to the storyboard system.

When the storyboard system is opened, as shown in FIG. 16, the storyboard system automatically sets the application state to the state of the last selected icon before the storyboard was shut down and closed. In some embodiments, the display step may include lines and arrows or any other symbols to show the association of the states linked to the icons or to show the sequence of these states. The display step may further include an annotation process to allow users to write and display any annotation in connection to the state and icon so that relevant annotations can be reviewed or presented later while viewing the diagram. In some embodiments, the icons may include a “button” next to them that can show or hide any linked icons when toggled. This option reduces clutter in the diagram and allows the user to focus on what is relevant at any time when using the diagram. In some other embodiments, the display step may include an update process configured in a way that the application state and annotation connected can be updated any time the associated icon is clicked. In some other embodiments, the display step may include navigation buttons such as “next” and “previous” buttons to allow the user to return to a previous state or view the next state.

The display step may further include a window control mechanism to allow users to pan and zoom around the diagram of the storyboard system to see the icons more easily as needed and hide or show the linked icons as needed.

The storyboard system provides the ability to monitor a software application, capture its current state (as defined above), and then set the software application to the state captured when “presenting” the diagram of the storyboard system.

The storyboard system may be part of any software application being enhanced by the storyboard feature, or it could be a separate software application that monitors, and controls other software applications being run by the storyboard system.

When the storyboard system is part of a software application, the storyboard system may be configured to be activated by a menu item in the software application.

When the storyboard system is provided as a separate software application, the storyboard system can be designed to monitor and control any software application, including an application interface for programmers to monitor and control.

The steps and the processes described in connection with the embodiments disclosed herein can be embodied directly in hardware, in a software module executed by a processor, or in a combination of the two. A software module can reside in a memory unit that can include volatile memory, non-volatile memory, and network devices, or other data storage devices now known or later developed for storing information/ data. The volatile memory may be any type of volatile memory including, but not limited to, static or dynamic, random access memory (SRAM or DRAM). The non-volatile memory may be any non-volatile memory including, but not limited to, ROM, EPROM, EEPROM, flash memory, and magnetically or optically readable memory or memory devices such as compact discs (CDs) or digital video discs (DVDs), magnetic tape, and hard drives.

The computing device may be a laptop computer, a cellular phone, a personal digital assistant (PDA), a tablet computer, and other mobile devices of the type. Communications between components and/or devices in the systems and methods disclosed herein may be unidirectional or bidirectional electronic communication through a wired or wireless configuration or network. For example, one component or device may be wired or networked wirelessly directly or indirectly, through a third party intermediary, over the Internet, or otherwise with another component or device to enable communication between the components or devices. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type. In example embodiments, network can be configured to provide and employ 5G wireless networking features and functionalities.

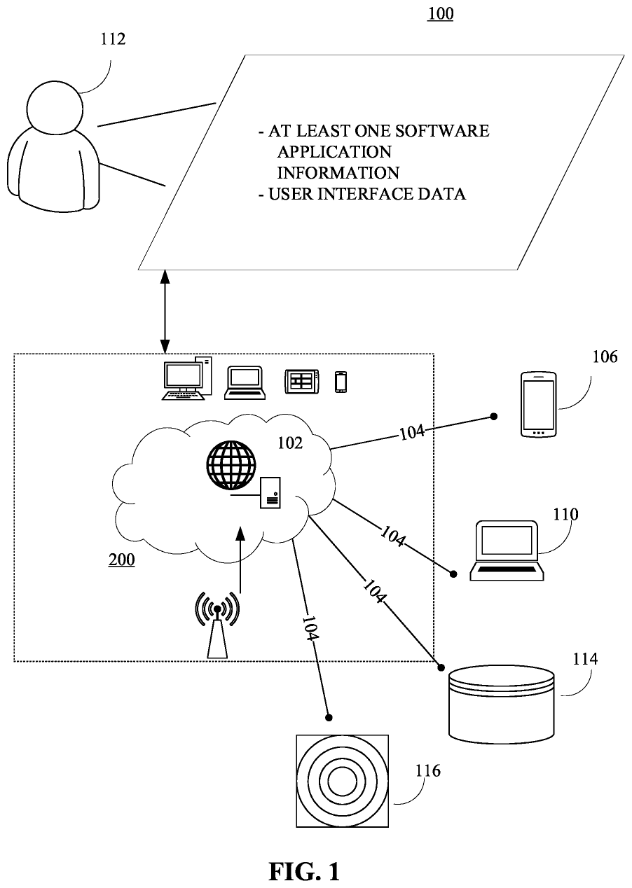

FIG. 1 is an illustration of an online platform 100 consistent with various embodiments of the present disclosure. By way of non-limiting example, the online platform 100 to enable facilitating management of employee data may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

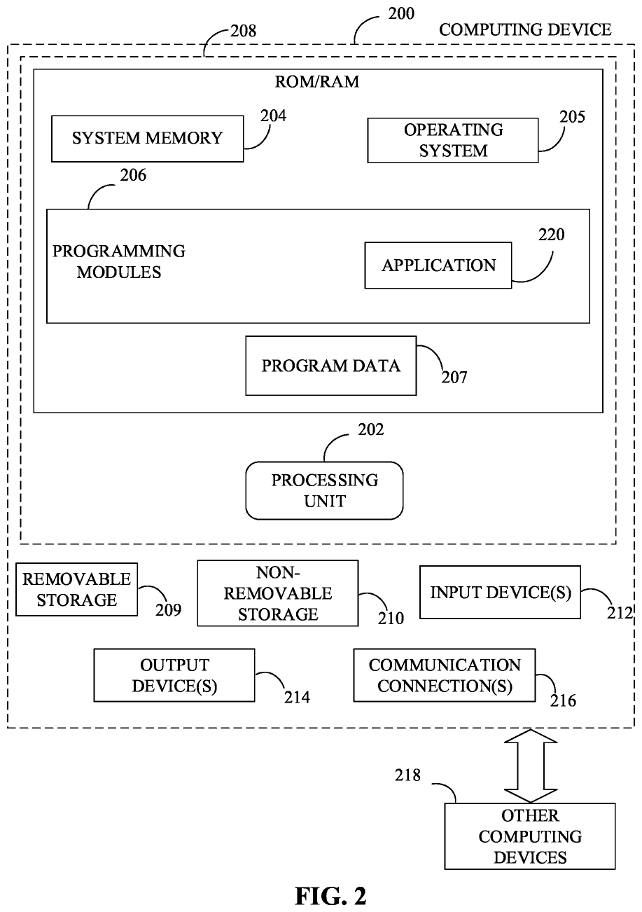

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

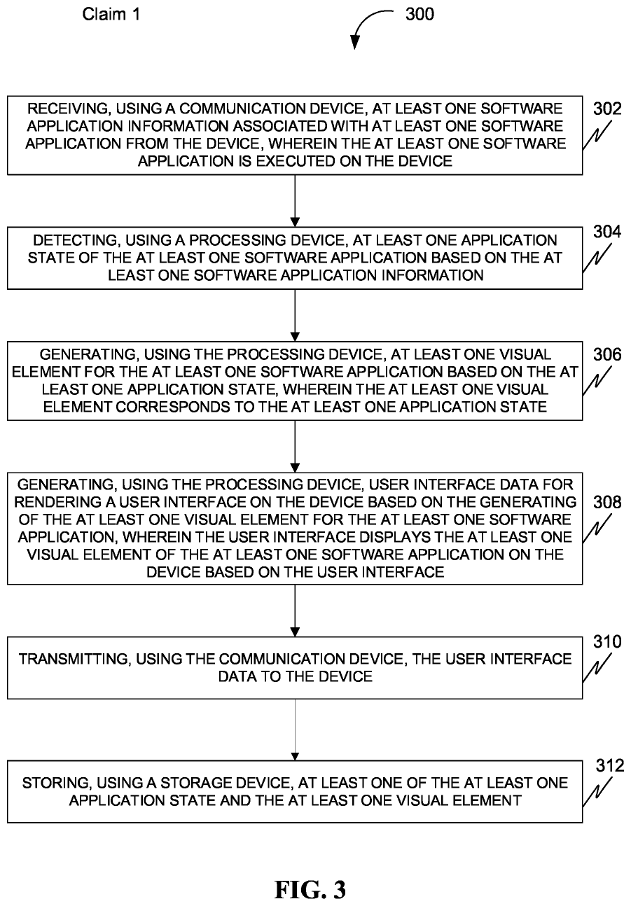

FIG. 3 illustrates a flowchart of a method 300 for organizing displays of software applications running on a device, in accordance with some embodiments.

Accordingly, the method 300 may include a step 302 of receiving, using a communication device (such as the communication device 1102), at least one software application information associated with at least one software application from the device, wherein the at least one software application is executed on the device. Further, the at least one software application information may include any information associated with the at least one software application. Further, the at least one software application may include a web application, a gaming application, a professional application, etc. Further, the device may include the at least one client device. Further, the method 300 may include a step 304 of detecting, using a processing device (such as the processing device 1104), at least one application state of the at least one software application based on the at least one software application information. Further, the at least one application state may include a state or a stage that indicates a progress of the at least one software application and a status of the at least one software application. Further, the status may correspond to a navigating status of one or more features of the at least one software application that a user associated with the device may navigate. Further, the method 300 may include a step 306 of generating, using the processing device, at least one visual element for the at least one software application based on the at least one application state, wherein the at least one visual element corresponds to the at least one application state. Further, the at least one visual element may include an icon. Further, the at least one visual element may form a diagram. Further, the method 300 may include a step 308 of generating, using the processing device, user interface data for rendering a user interface on the device based on the generating of the at least one visual element for the at least one software application, wherein the user interface displays the at least one visual element of the at least one software application on the device based on the user interface. Further, the method 300 may include a step 310 of transmitting, using the communication device, the user interface data to the device. Further, the method 300 may include a step 312 of storing, using a storage device (such as the storage device 1106), at least one of the at least one application state and the at least one visual element.

In some embodiments, the at least one application state may include at least one of at least one viewing state, at least one application status, and at least one location of the at least one software application. Further, at least one of the at least one viewing state, the at least one application status, and the at least one location of the at least one software application may be dynamic based on executing of the at least one software application on the device.

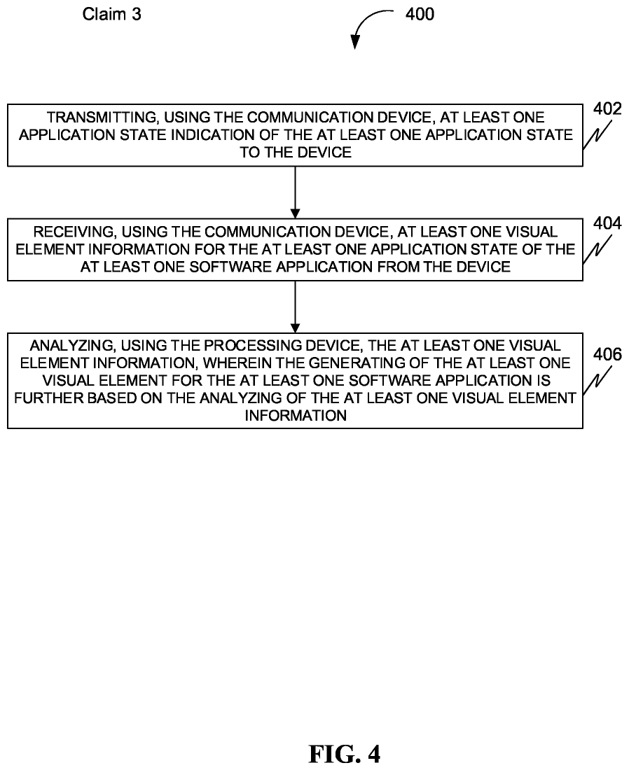

FIG. 4 illustrates a flowchart of the method 400 for organizing displays of software applications running on a device including analyzing, using a processing device, at least one visual element information, wherein generating of the at least one visual element for at least one software application is further based on the analyzing of the at least one visual element information, in accordance with some embodiments.

Further, the method 400 may include a step 402 of transmitting, using the communication device, at least one application state indication of the at least one application state to the device. Further, the method 400 may include a step 404 of receiving, using the communication device, at least one visual element information for the at least one application state of the at least one software application from the device. Further, the at least one visual element information may include any information associated with the at least one application state corresponding to the at least one visual element. Further, the method 400 may include a step 406 of analyzing, using the processing device, the at least one visual element information, wherein the generating of the at least one visual element for the at least one software application is further based on the analyzing of the at least one visual element information.

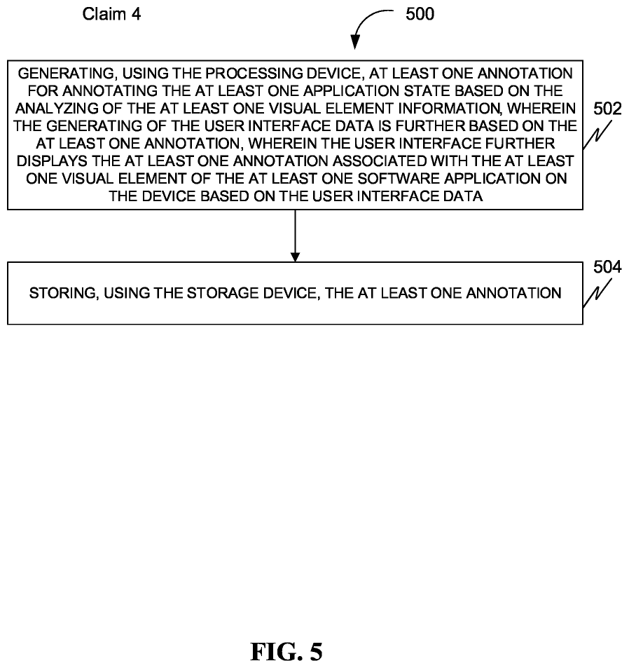

FIG. 5 illustrates a flowchart of the method 500 for organizing displays of software applications running on a device including storing, using a storage device, at least one annotation, in accordance with some embodiments.

Further, the method 500 may include a step 502 of generating, using the processing device, at least one annotation for annotating the at least one application state based on the analyzing of the at least one visual element information, wherein the generating of the user interface data is further based on the at least one annotation, wherein the user interface further displays the at least one annotation associated with the at least one visual element of the at least one software application on the device based on the user interface data. Further, the at least one annotation may include at least one digital content comprising a text, an image, a video, an audio, etc. Further, the method 500 may include a step 504 of storing, using the storage device, the at least one annotation.

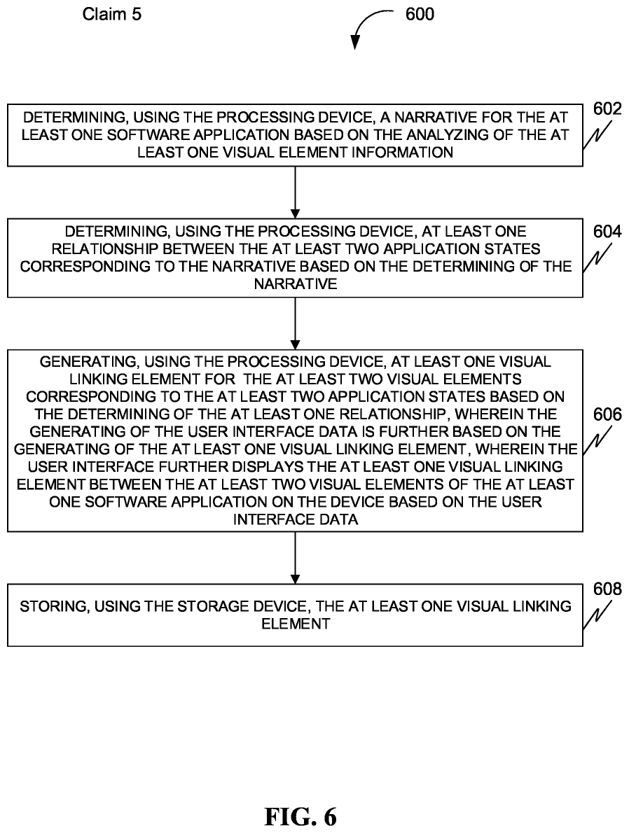

FIG. 6 illustrates a flowchart of the method 600 for organizing displays of software applications running on a device including storing, using a storage device, at least one visual linking element, in accordance with some embodiments.

Further, the at least one application state may include at least two application states. Further, the at least one visual element may include at least two visual elements. Further, the method 600 may include a step 602 of determining, using the processing device, a narrative for the at least one software application based on the analyzing of the at least one visual element information. Further, the narrative may include a context of the at least one software application. Further, the method 600 may include a step 604 of determining, using the processing device, at least one relationship between the at least two application states corresponding to the narrative based on the determining of the narrative. Further, the method 600 may include a step 606 of generating, using the processing device, at least one visual linking element for the at least two visual elements corresponding to the at least two application states based on the determining of the at least one relationship, wherein the generating of the user interface data is further based on the generating of the at least one visual linking element, wherein the user interface further displays the at least one visual linking element between the at least two visual elements of the at least one software application on the device based on the user interface data. Further, the at least one visual linking element may include at least one arrow, a line, etc. linking the at least two visual elements. Further, the method 600 may include a step 608 of storing, using the storage device, the at least one visual linking element.

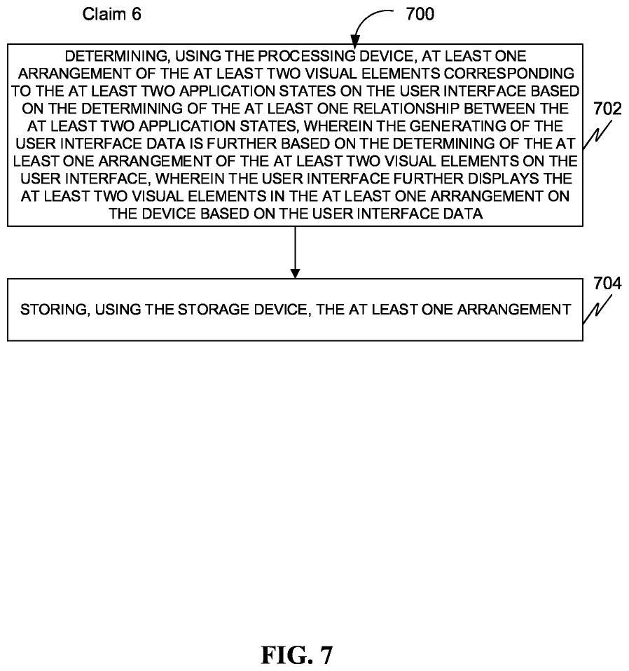

FIG. 7 illustrates a flowchart of the method 700 for organizing displays of software applications running on a device including storing, using a storage device, at least one arrangement, in accordance with some embodiments.

Further, the method 700 may include a step 702 of determining, using the processing device, at least one arrangement of the at least two visual elements corresponding to the at least two application states on the user interface based on the determining of the at least one relationship between the at least two application states, wherein the generating of the user interface data is further based on the determining of the at least one arrangement of the at least two visual elements on the user interface, wherein the user interface further displays the at least two visual elements in the at least one arrangement on the device based on the user interface data. Further, the method 700 may include a step 704 of storing, using the storage device, the at least one arrangement. Further, the at least one arrangement may include a spatial position of the at least two visual elements in the user interface. Further, the at least two visual elements are arranged in the at least one arrangement in the user interface. Further, arranging of the at least two visual elements facilitates organizing, sequencing of the at least two visual elements.

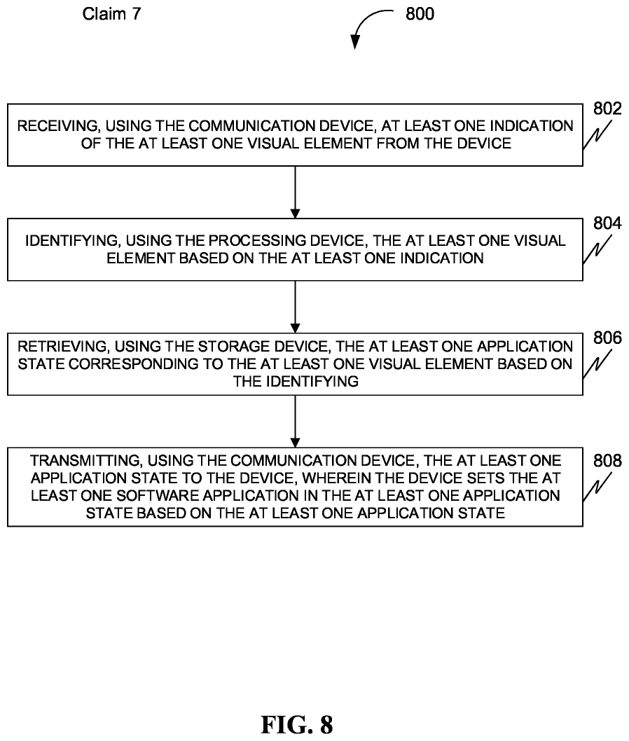

FIG. 8 illustrates a flowchart of the method 800 for organizing displays of software applications running on a device including transmitting, using a communication a device, at least one application state to the device, wherein the device sets at least one software application in the at least one application state based on the at least one application state, in accordance with some embodiments.

Further, the method 800 may include a step 802 of receiving, using the communication device, at least one indication of the at least one visual element from the device. Further, the method 800 may include a step 804 of identifying, using the processing device, the at least one visual element based on the at least one indication. Further, the method 800 may include a step 806 of retrieving, using the storage device, the at least one application state corresponding to the at least one visual element based on the identifying. Further, the method 800 may include a step 808 of transmitting, using the communication device, the at least one application state to the device, wherein the device sets the at least one software application in the at least one application state based on the at least one application state.

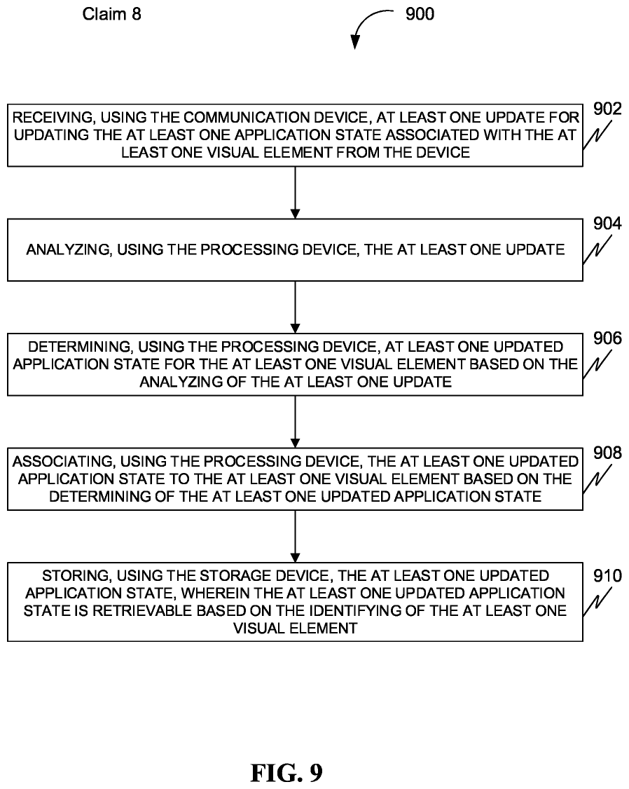

FIG. 9 illustrates a flowchart of the method 900 for organizing displays of software applications running on a device including storing, using a storage device, at least one updated application state, wherein the at least one updated application state is retrievable based on identifying of at least one visual element, in accordance with some embodiments.

Further, the method 900 may include a step 902 of receiving, using the communication device, at least one update for updating the at least one application state associated with the at least one visual element from the device. Further, the method 900 may include a step 904 of analyzing, using the processing device, the at least one update. Further, the method 900 may include a step 906 of determining, using the processing device, at least one updated application state for the at least one visual element based on the analyzing of the at least one update. Further, the method 900 may include a step 908 of associating, using the processing device, the at least one updated application state to the at least one visual element based on the determining of the at least one updated application state. Further, the method 900 may include a step 910 of storing, using the storage device, the at least one updated application state, wherein the at least one updated application state is retrievable based on the identifying of the at least one visual element.

In some embodiments, the at least one software application information may include at least one request for capturing the at least one application state of the at least one software application. Further, the detecting of the at least one application state may include capturing the at least one application state of the at least one software application.

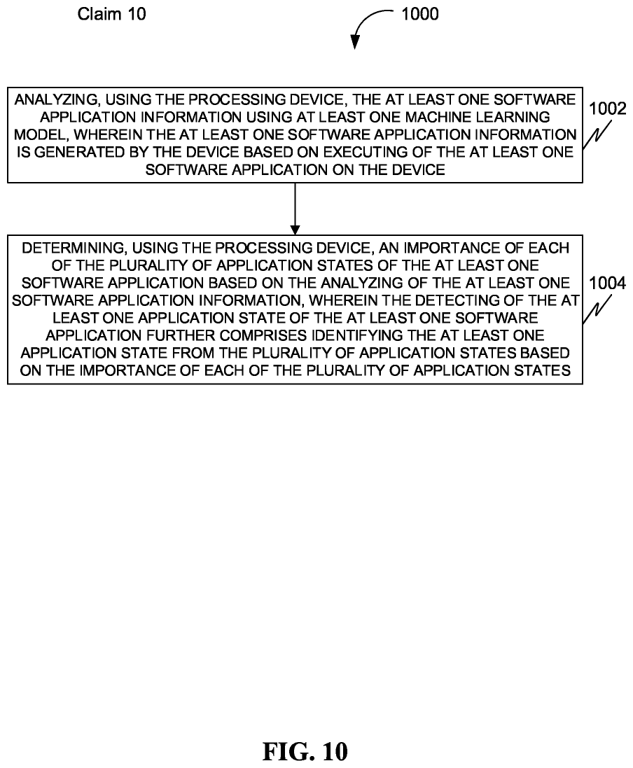

FIG. 10 illustrates a flowchart of the method 1000 for organizing displays of software applications running on a device including determining, using a processing device, an importance of each of a plurality of application states of at least one software application based on analyzing of the at least one software application information, wherein detecting of at least one application state of the at least one software application further comprises identifying the at least one application state from the plurality of application states based on the importance of each of the plurality of application states, in accordance with some embodiments.

Further, the at least one software application information may be associated with a plurality of application states of the at least one software application. Further, the method 1000 may include a step 1002 of analyzing, using the processing device, the at least one software application information using at least one machine learning model, wherein the at least one software application information is generated by the device based on executing of the at least one software application on the device. Further, the at least one machine learning model detects an amount of time spent by the at least one software application in an application state of the at least one software application, a recency of the at least one software application in the application state, an amount of data consumed by the at least one software application in the application state, etc. Further, the method 1000 may include a step 1004 of determining, using the processing device, an importance of each of the plurality of application states of the at least one software application based on the analyzing of the at least one software application information, wherein the detecting of the at least one application state of the at least one software application further comprises identifying the at least one application state from the plurality of application states based on the importance of each of the plurality of application states. Further, the importance corresponds a higher amount of time spent on the at least one software application in the application state, a near recency of the at least one software application in the application state, a higher amount of data consumed by the at least one software application in the application state, etc.

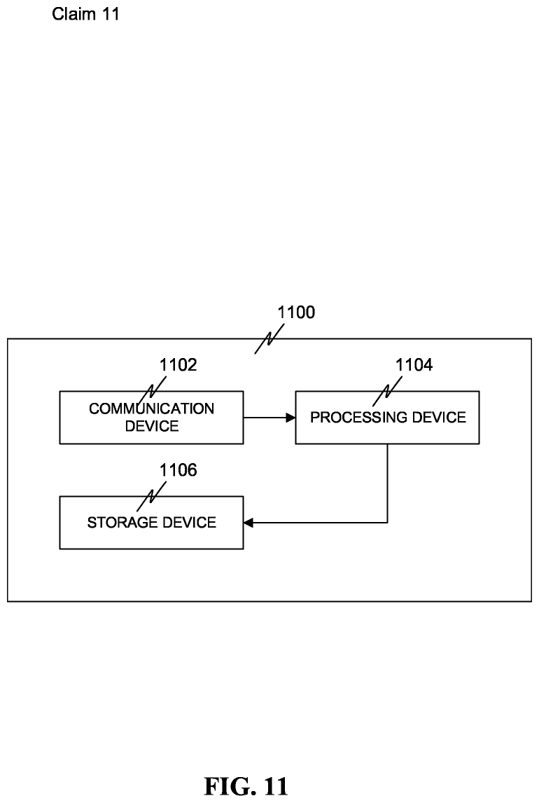

FIG. 11 illustrates a block diagram of a system 1100 for organizing displays of software applications running on a device 1202, in accordance with some embodiments.

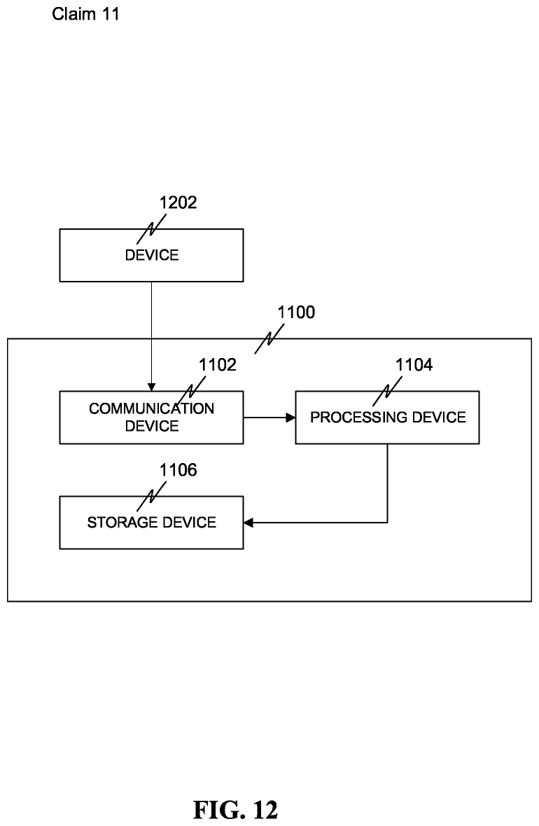

Accordingly, the system 1100 may include a communication device 1102. Further, the communication device 1102 may be configured for receiving at least one software application information associated with at least one software application from the device 1202, as shown in FIG. 12. Further, the device 1202 may include the at least one client device. Further, the at least one software application may be executed on the device 1202. Further, the communication device 1102 may be configured for transmitting user interface data to the device 1202. Further, the system 1100 may include a processing device 1104 communicatively coupled with the communication device 1102. Further, the processing device 1104 may be configured for detecting at least one application state of the at least one software application based on the at least one software application information. Further, the processing device 1104 may be configured for generating at least one visual element for the at least one software application based on the at least one application state. Further, the at least one visual element corresponds to the at least one application state. Further, the processing device 1104 may be configured for generating the user interface data for rendering a user interface on the device 1202 based on the generating of the at least one visual element for the at least one software application. Further, the user interface may display the at least one visual element of the at least one software application on the device 1202 based on the user interface data. Further, the system 1100 may include a storage device 1106 communicatively coupled with the processing device 1104. Further, the storage device 1106 may be configured for storing at least one of the at least one application state and the at least one visual element.

In some embodiments, the at least one application state may include at least one of at least one viewing state, at least one application status, and at least one location of the at least one software application. Further, at least one of the at least one viewing state, the at least one application status, and the at least one location of the at least one software application may be dynamic based on executing of the at least one software application on the device 1202.

Further, in some embodiments, the communication device 1102 may be configured for transmitting at least one application state indication of the at least one application state to the device 1202. Further, the communication device 1102 may be configured for receiving at least one visual element information for the at least one application state of the at least one software application from the device 1202. Further, the processing device 1104 may be further configured for analyzing the at least one visual element information. Further, the generating of the at least one visual element for the at least one software application may be further based on the analyzing of the at least one visual element information.

In some embodiments, the processing device 1104 may be further configured for generating at least one annotation for annotating the at least one application state based on the analyzing of the at least one visual element information. Further, the generating of the user interface data may be further based on the at least one annotation. Further, the user interface further may display the at least one annotation associated with the at least one visual element of the at least one software application on the device 1202 based on the user interface data. Further, the storage device 1106 may be further configured for storing the at least one annotation.

Further, in some embodiments, the at least one application state may include at least two application states. Further, the at least one visual element may include at least two visual elements. Further, the processing device 1104 may be configured for determining a narrative for the at least one software application based on the analyzing of the at least one visual element information. Further, the at least one application state may include at least two application states. Further, the at least one visual element may include at least two visual elements. Further, the processing device 1104 may be configured for determining at least one relationship between the at least two application states corresponding to the narrative based on the determining of the narrative. Further, the at least one application state may include at least two application states. Further, the at least one visual element may include at least two visual elements. Further, the processing device 1104 may be configured for generating at least one visual linking element for the at least two visual elements corresponding to the at least two application states based on the determining of the at least one relationship. Further, the generating of the user interface data may be further based on the generating of the at least one visual linking element. Further, the user interface further may display the at least one visual linking element between the at least two visual elements of the at least one software application on the device 1202 based on the user interface data. Further, the storage device 1106 may be further configured for storing the at least one visual linking element.

In some embodiments, the processing device 1104 may be further configured for determining at least one arrangement of the at least two visual elements corresponding to the at least two application states on the user interface based on the determining of the at least one relationship between the at least two application states. Further, the generating of the user interface data may be further based on the determining of the at least one arrangement of the at least two visual elements on the user interface. Further, the user interface may display the at least two visual elements in the at least one arrangement on the device 1202 based on the user interface data. Further, the storage device 1106 may be further configured for storing the at least one arrangement.

Further, in some embodiments, the communication device 1102 may be configured for receiving at least one indication of the at least one visual element from the device 1202. Further, the communication device 1102 may be configured for transmitting the at least one application state to the device 1202. Further, the device 1202 may set the at least one software application in the at least one application state based on the at least one application state. Further, the processing device 1104 may be further configured for identifying the at least one visual element based on the at least one indication. Further, the storage device 1106 may be further configured for retrieving the at least one application state corresponding to the at least one visual element based on the identifying.

Further, in some embodiments, the communication device 1102 may be configured for receiving at least one update for updating the at least one application state associated with the at least one visual element from the device 1202. Further, the processing device 1104 may be configured for analyzing the at least one update. Further, the communication device 1102 may be configured for receiving at least one update for updating the at least one application state associated with the at least one visual element from the device 1202. Further, the processing device 1104 may be configured for determining at least one updated application state for the at least one visual element based on the analyzing of the at least one update. Further, the communication device 1102 may be configured for receiving at least one update for updating the at least one application state associated with the at least one visual element from the device 1202. Further, the processing device 1104 may be configured for associating the at least one updated application states to the at least one visual element based on the determining of the at least one updated application state. Further, the storage device 1106 may be further configured for storing the at least one updated application state. Further, the at least one updated application state may be retrievable based on the identifying of the at least one visual element.

In some embodiments, the at least one software application information may include at least one request for capturing the at least one application state of the at least one software application. Further, the detecting of the at least one application state may include capturing the at least one application state of the at least one software application.

Further, in some embodiments, the at least one software application information may be associated with a plurality of application states of the at least one software application. Further, the processing device 1104 may be configured for analyzing the at least one software application information using at least one machine learning model. Further, the at least one software application information may be generated by the device 1202 based on executing of the at least one software application on the device 1202. Further, the processing device 1104 may be configured for determining an importance of each of the plurality of application states of the at least one software application based on the analyzing of the at least one software application information. Further, the detecting of the at least one application state of the at least one software application may further include identifying the at least one application state from the plurality of application states based on the importance of each of the plurality of application states.

FIG. 12 illustrates a block diagram of the system 1100 for organizing the displays of the software applications running on the device 1202, in accordance with some embodiments.

FIG. 13 illustrates a block diagram of a storyboard system 1300 for organizing displays of software applications running on a device (such as the device 1202), in accordance with some embodiments. Further, the storyboard system 1300 may include one or more processors (such as the processing device 1104) and one or more memories (such as the storage device 1106). Further, the one or more processors may be communicatively coupled with the one or more memories. Further, the one or more memories may include one or more instructions. Further, the one or more processors may be configured for executing the one or more instructions for triggering an input step 1302 and a display step 1304. Further, the one or more instructions may include routines, programs, objects, data structures, etc. Further, the storyboard system 1300 may be implemented in a network environment. Further, the network environment may include e one or more servers.

FIG. 14 illustrates a block diagram of the storyboard system 1300, in accordance with some embodiments. Further, the input step 1302 may include a capture process 1402. Further, the display step 1304 may include a display process 1404 and an annotation process 1406.

FIG. 15 illustrates a user interface 1500 of the device, in accordance with some embodiments. Further, the user interface 1500 displays a plurality of visual elements 1502-1508. Further, the plurality of visual elements 1502-1508 may include icons. Further, the plurality of visual elements 1502-1508 may be associated with an annotation 1510 and an application state 1512 associated with a software application. Further, the annotation 1510 and the application state 1512 may be comprised in one of the plurality of visual elements 1502-1508.

FIG. 16 illustrates storyboard interfaces 1602-1608 associated with the storyboard system 1300, in accordance with some embodiments.

Although the present disclosure has been explained in relation to its preferred embodiment, it is to be understood that many other possible modifications and variations can be made without departing from the spirit and scope of the disclosure.

1. A method for organizing displays of software applications running on a device, the method comprising:
receiving, using a communication device, at least one software application information associated with at least one software application from the device, wherein the at least one software application is executed on the device;
detecting, using a processing device, at least one application state of the at least one software application based on the at least one software application information;
generating, using the processing device, at least one visual element for the at least one software application based on the at least one application state, wherein the at least one visual element corresponds to the at least one application state;
generating, using the processing device, user interface data for rendering a user interface on the device based on the generating of the at least one visual element for the at least one software application, wherein the user interface displays the at least one visual element of the at least one software application on the device based on the user interface;
transmitting, using the communication device, the user interface data to the device; and
storing, using a storage device, at least one of the at least one application state and the at least one visual element.

2. The method of claim 1, wherein the at least one application state comprises at least one of at least one viewing state, at least one application status, and at least one location of the at least one software application, wherein at least one of the at least one viewing state, the at least one application status, and the at least one location of the at least one software application is dynamic based on executing of the at least one software application on the device.

3. The method of claim 1 further comprising:
transmitting, using the communication device, at least one application state indication of the at least one application state to the device;
receiving, using the communication device, at least one visual element information for the at least one application state of the at least one software application from the device; and
analyzing, using the processing device, the at least one visual element information, wherein the generating of the at least one visual element for the at least one software application is further based on the analyzing of the at least one visual element information.

4. The method of claim 3 further comprising:
generating, using the processing device, at least one annotation for annotating the at least one application state based on the analyzing of the at least one visual element information, wherein the generating of the user interface data is further based on the at least one annotation, wherein the user interface further displays the at least one annotation associated with the at least one visual element of the at least one software application on the device based on the user interface data; and
storing, using the storage device, the at least one annotation.

5. The method of claim 3, wherein the at least one application state comprises at least two application states, wherein the at least one visual element comprises at least two visual elements, wherein the method further comprises:
determining, using the processing device, a narrative for the at least one software application based on the analyzing of the at least one visual element information;
determining, using the processing device, at least one relationship between the at least two application states corresponding to the narrative based on the determining of the narrative;
generating, using the processing device, at least one visual linking element for the at least two visual elements corresponding to the at least two application states based on the determining of the at least one relationship, wherein the generating of the user interface data is further based on the generating of the at least one visual linking element, wherein the user interface further displays the at least one visual linking element between the at least two visual elements of the at least one software application on the device based on the user interface data; and
storing, using the storage device, the at least one visual linking element.

6. The method of claim 5 further comprising:
determining, using the processing device, at least one arrangement of the at least two visual elements corresponding to the at least two application states on the user interface based on the determining of the at least one relationship between the at least two application states, wherein the generating of the user interface data is further based on the determining of the at least one arrangement of the at least two visual elements on the user interface, wherein the user interface further displays the at least two visual elements in the at least one arrangement on the device based on the user interface data; and
storing, using the storage device, the at least one arrangement.

7. The method of claim 1 further comprising:
receiving, using the communication device, at least one indication of the at least one visual element from the device;
identifying, using the processing device, the at least one visual element based on the at least one indication;
retrieving, using the storage device, the at least one application state corresponding to the at least one visual element based on the identifying; and
transmitting, using the communication device, the at least one application state to the device, wherein the device sets the at least one software application in the at least one application state based on the at least one application state.

8. The method of claim 7 further comprising:
receiving, using the communication device, at least one update for updating the at least one application state associated with the at least one visual element from the device;
analyzing, using the processing device, the at least one update;
determining, using the processing device, at least one updated application state for the at least one visual element based on the analyzing of the at least one update;
associating, using the processing device, the at least one updated application state to the at least one visual element based on the determining of the at least one updated application state; and
storing, using the storage device, the at least one updated application state, wherein the at least one updated application state is retrievable based on the identifying of the at least one visual element.

9. The method of claim 1, wherein the at least one software application information comprises at least one request for capturing the at least one application state of the at least one software application, wherein the detecting of the at least one application state comprises capturing the at least one application state of the at least one software application.

10. The method of claim 1, wherein the at least one software application information is associated with a plurality of application states of the at least one software application, wherein the method further comprises:
analyzing, using the processing device, the at least one software application information using at least one machine learning model, wherein the at least one software application information is generated by the device based on executing of the at least one software application on the device; and
determining, using the processing device, an importance of each of the plurality of application states of the at least one software application based on the analyzing of the at least one software application information, wherein the detecting of the at least one application state of the at least one software application further comprises identifying the at least one application state from the plurality of application states based on the importance of each of the plurality of application states.

11. A system for organizing displays of software applications running on a device, the system comprising:
a communication device configured for:
receiving at least one software application information associated with at least one software application from the device, wherein the at least one software application is executed on the device; and
transmitting user interface data to the device;
a processing device communicatively coupled with the communication device, wherein the processing device is configured for:
detecting at least one application state of the at least one software application based on the at least one software application information;
generating at least one visual element for the at least one software application based on the at least one application state, wherein the at least one visual element corresponds to the at least one application state; and
generating the user interface data for rendering a user interface on the device based on the generating of the at least one visual element for the at least one software application, wherein the user interface displays the at least one visual element of the at least one software application on the device based on the user interface data; and
a storage device communicatively coupled with the processing device, wherein the storage device is configured for storing at least one of the at least one application state and the at least one visual element.

12. The system of claim 11, wherein the at least one application state comprises at least one of at least one viewing state, at least one application status, and at least one location of the at least one software application, wherein at least one of the at least one viewing state, the at least one application status, and the at least one location of the at least one software application is dynamic based on executing of the at least one software application on the device.

13. The system of claim 11, wherein the communication device is further configured for:
transmitting at least one application state indication of the at least one application state to the device; and
receiving at least one visual element information for the at least one application state of the at least one software application from the device, wherein the processing device is further configured for analyzing the at least one visual element information, wherein the generating of the at least one visual element for the at least one software application is further based on the analyzing of the at least one visual element information.

14. The system of claim 13, wherein the processing device is further configured for generating at least one annotation for annotating the at least one application state based on the analyzing of the at least one visual element information, wherein the generating of the user interface data is further based on the at least one annotation, wherein the user interface further displays the at least one annotation associated with the at least one visual element of the at least one software application on the device based on the user interface data, wherein the storage device is further configured for storing the at least one annotation.

15. The system of claim 13, wherein the at least one application state comprises at least two application states, wherein the at least one visual element comprises at least two visual elements, wherein the processing device is further configured for:
determining a narrative for the at least one software application based on the analyzing of the at least one visual element information;
determining at least one relationship between the at least two application states corresponding to the narrative based on the determining of the narrative; and
generating at least one visual linking element for the at least two visual elements corresponding to the at least two application states based on the determining of the at least one relationship, wherein the generating of the user interface data is further based on the generating of the at least one visual linking element, wherein the user interface further displays the at least one visual linking element between the at least two visual elements of the at least one software application on the device based on the user interface data, wherein the storage device is further configured for storing the at least one visual linking element.

16. The system of claim 15, wherein the processing device is further configured for determining at least one arrangement of the at least two visual elements corresponding to the at least two application states on the user interface based on the determining of the at least one relationship between the at least two application states, wherein the generating of the user interface data is further based on the determining of the at least one arrangement of the at least two visual elements on the user interface, wherein the user interface further displays the at least two visual elements in the at least one arrangement on the device based on the user interface data, wherein the storage device is further configured for storing the at least one arrangement.

17. The system of claim 11, wherein the communication device is further configured for:
receiving at least one indication of the at least one visual element from the device; and
transmitting the at least one application state to the device, wherein the device sets the at least one software application in the at least one application state based on the at least one application state, wherein the processing device is further configured for identifying the at least one visual element based on the at least one indication, wherein the storage device is further configured for retrieving the at least one application state corresponding to the at least one visual element based on the identifying.

18. The system of claim 17, wherein the communication device is further configured for receiving at least one update for updating the at least one application state associated with the at least one visual element from the device, wherein the processing device is further configured for:
analyzing the at least one update;
determining at least one updated application state for the at least one visual element based on the analyzing of the at least one update; and
associating the at least one updated application state to the at least one visual element based on the determining of the at least one updated application state, wherein the storage device is further configured for storing the at least one updated application state, wherein the at least one updated application state is retrievable based on the identifying of the at least one visual element.

19. The system of claim 11, wherein the at least one software application information comprises at least one request for capturing the at least one application state of the at least one software application, wherein the detecting of the at least one application state comprises capturing the at least one application state of the at least one software application.

20. The system of claim 11, wherein the at least one software application information is associated with a plurality of application states of the at least one software application, wherein the processing device is further configured for:
analyzing the at least one software application information using at least one machine learning model, wherein the at least one software application information is generated by the device based on executing of the at least one software application on the device; and
determining an importance of each of the plurality of application states of the at least one software application based on the analyzing of the at least one software application information, wherein the detecting of the at least one application state of the at least one software application further comprises identifying the at least one application state from the plurality of application states based on the importance of each of the plurality of application states.
